(19) United States
(12) Patent Application Publication
(10) Pub. No.: US 2020/0215590 A1
(43) Pub. Date: Jul. 9, 2020

(54) Paw type quick guiding dredging device for household sewer pipe

(71) Applicant: Fudong PAN, Hong Kong (HK)

(72) Inventor: Fudong PAN, Hong Kong (HK)

(21) Appl. No.: 16/281,124

(22) Filed: Feb. 21, 2019

(30) Foreign Application Priority Data
Jan. 9, 2019 (CN) 201910020507.6

(51) Int. Cl. B08B 9/045; E03F 9/00

(52) U.S. Cl. CPC B08B 9/045; E03F 9/002

(57) ABSTRACT

The invention relates to a paw type quick guiding dredging device for household sewer pipe which includes a feeding air guiding tube, a micro air pump and a dredging member. One end of the feeding air guiding tube is a closed structure, and the other end is provided with a connecting sleeve. The dredging member includes an extended air guiding tube and a spherical airbag. One end of the extended air guiding tube is connected with the connecting sleeve. The inlet end of the spherical airbag is in communication with the other end of the extended air guiding tube. The outer surface of the spherical airbag is provided with a friction member which is used to clean the inner wall of sewage pipe. One end of the feeding air guiding tube close to the connecting sleeve is further provided with a sliding member for pulling the spherical airbag. The outer surface of the extended air guiding tube is hinged with a hooking member for hooking the blockage in the sewage pipe. The output end of the micro air pump is in communication with the end of the feeding air guiding tube away from the connecting sleeve. The paw type quick guiding dredging device for household sewer pipe can fully clean the dirt in the sewage pipe or block foreign matter without damaging the pipeline, which is greatly convenient for people's daily life.

### FIELD OF THE INVENTION

The invention relates to sewer pipe dredging, in particular, to a paw type quick guiding dredging device for household sewer pipe.

### BACKGROUND

In the home life, the sewer pipe or the sink will be blocked by the accumulation of foreign objects due to long-term use. Most of these foreign objects are the hair produced by people when they bathe, and some leaves and hard things when washing vegetables, and the long-term dirt on the inner wall of the pipe. Although it fails to cause complete blockage, the drainage process will become very slow. The traditional dredging sewer pipe mainly uses manual rocking wire or chemical preparation to corrode the plugging in the sewer pipe. The disadvantage of the former is insufficient cleaning, and it will still be blocked for a short time. The latter will damage the pipe due to its chemical properties. If the sewer pipe is damaged, the consequences will be greater than the blockage.

### SUMMARY OF THE INVENTION

The technical problem to be solved is to overcome the above-mentioned deficiency by providing a paw type quick guiding dredging device for household sewer pipe.

To solve the above deficiency, the present invention provides the following technical solution.

A paw type quick guiding dredging device for household sewer pipe includes a feeding air guiding tube, a micro air pump and a dredging member. One end of the feeding air guiding tube is a closed structure, and the other end is provided with a connecting sleeve communicating with the coaxial line thereof. The dredging member includes an extended air guiding tube and a spherical airbag. One end of the extended air guiding tube is connected with the connecting sleeve. The inlet end of the spherical airbag is in communication with the other end of the extended air guiding tube. The spherical airbag, the extended air guiding tube and the connecting sleeve are coaxially arranged, and the outer surface of the spherical airbag is provided with a friction member which is used to clean the inner wall of sewage pipe. One end of the feeding air guiding tube close to the connecting sleeve is further provided with a sliding member for pulling the spherical airbag. The outer surface of the extended air guiding tube is hinged with a hooking member for hooking the blockage in the sewage pipe. The output end of the micro air pump is in communication with the end of the feeding air guiding tube away from the connecting sleeve.

Further, the friction member includes a plurality of soft brushes spaced apart in the circumferential direction of the spherical airbag, and the spherical airbag is made of rubber.

Further, the outer surface of the spherical airbag is provided with a plurality of mounting slots distributed along the circumferential direction thereof, and all the mounting slots are placed separately from the soft brushes. The mounting slots are provided with rectangular blocks, and one side of the rectangular block facing outward has a rectangular hinge groove. The rectangular hinge groove is provided with a guide wheel that can rotate along its own axis.

Further, the axial direction of the guide wheel is perpendicular to the axial direction of the spherical airbag, and the diameter of the guide wheel is larger than the depth of the rectangular hinge groove.

Further, the hooking member includes at least four hooks equally spaced along the circumferential direction of the extended air guiding tube, and the outer side of the extended air guiding tube is provided with at least four rotating slots spaced along the circumferential direction thereof. All the hooks respectively correspond to all the rotating slots, the hooking end of the hook is suspended outside the rotating slot, and the other end is hingedly disposed in the rotating slot. The rotating slot is disposed at an end of the extended air guiding tube close to the spherical airbag.

Further, the feeding air guiding tube is a rubber hose, and the sliding member includes an elastic rope. One end of the elastic rope is fixedly connected with the outer side surface of the feeding air guiding tube, and the length of the elastic rope is the same as the length of the feeding air guiding tube.

Further, the end of the feeding air guiding tube away from the connecting sleeve is provided with a portable handle integrally formed with the feeding air guiding tube.

The present invention provides a paw type quick guiding dredging device for household sewer pipe. A hand-held portable hand sequentially inserts a spherical airbag, an extended air guiding tube, an elastic rope, a connecting sleeve and a feeding air guiding tube into the sewage pipe. As the feeding air guiding tube is a rubber hose, it passes through the bend of the sewage pipe and does not get stuck. The spherical airbag enters the bend. At this time, one end of the hook is vertically suspended, and the movement of the spherical airbag in the sewage pipe is not affected. Then the air source is manually sent through the feeding air guiding pipe, the connecting sleeve and the extended air guiding tube through the micro air pump to the airbag, which makes the spherical airbag expand and contact the inner wall of the sewage pipe. During expansion, the upper part of the spherical airbag contacts the hooking end of the hook, and make the hook rotate upward, so that the hooking end of the hook contacts the blockage, such as hair. Then one hand manually pulls the portable handle, and the other hand pulls the elastic rope, which makes the spherical airbag reciprocate in the sewage pipe. The soft brush contacts the dirt in the sewage pipe. At this time, the water source is discharged into the sewage pipe, and the guide wheel constitutes a guide, so that the spherical airbag moves. This makes the soft brush clean more sufficiently. The invention can fully clean the dirt in the sewage pipe or block foreign matter without damaging the pipeline, which is greatly convenient for people's daily life.

### BRIEF DESCRIPTION OF THE DRAWINGS

The invention is illustrated by the following figures and embodiments.

FIG. 1 shows a schematic diagram of 3D structure of a paw type quick guiding dredging device for household sewer pipe in accordance with an example embodiment.

FIG. 2 shows a schematic diagram of 3D structure of a paw type quick guiding dredging device for household sewer pipe in accordance with an example embodiment.

FIG. 3 shows a partial schematic diagram of 3D structure of a paw type quick guiding dredging device for household sewer pipe in accordance with an example embodiment.

FIG. 4 shows an enlarged view of A of FIG. 3.

FIG. 5 shows a partial schematic diagram of 3D structure of a paw type quick guiding dredging device for household sewer pipe in accordance with an example embodiment.

The reference numbers of the figures are as follows:

1: feeding air guiding tube; 2: connecting sleeve; 3: micro air pump; 4: dredging member; 4a: extended air guiding tube; 4a1: rotating slot; 4b: spherical airbag; 4b1: mounting slot; 4b2: rectangular block; 4b3: guide wheel; 4b4: rectangular hinge slot; 5: soft brush; 6: hook; 7: elastic rope; 8: portable handle.

### DETAILED DESCRIPTION

The invention is illustrated in accordance with figures. The figures as simplified diagrams demonstrate the basic structures of the apparatus of embodiments of the invention. Thus, the invention is not limited to the figures.

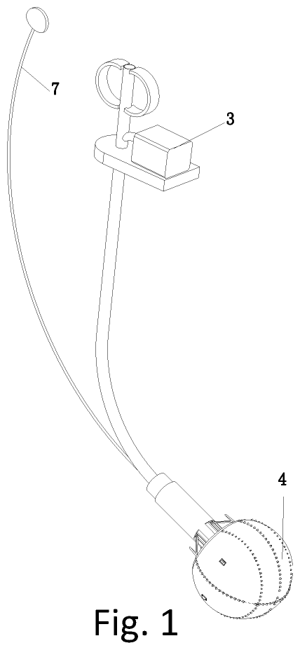

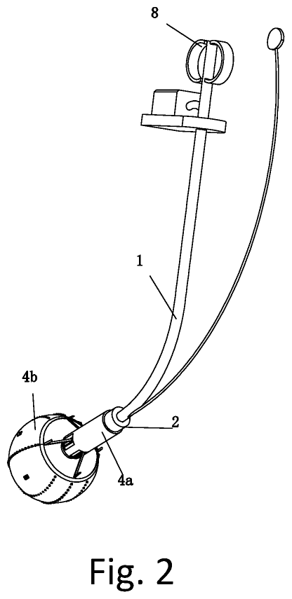

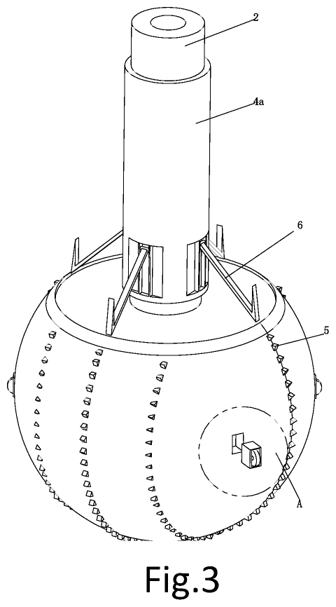

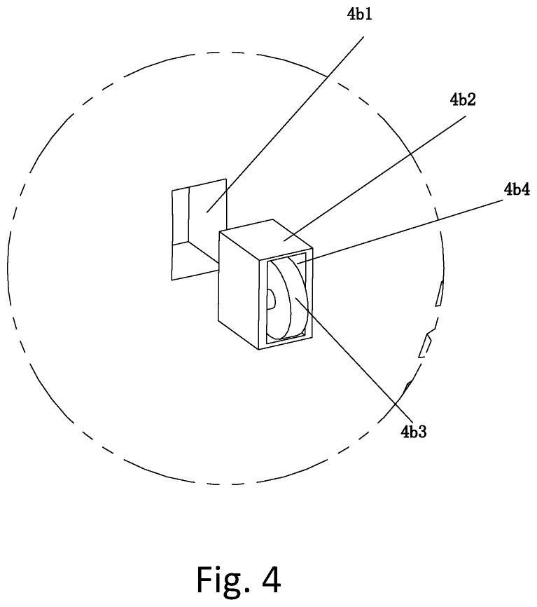

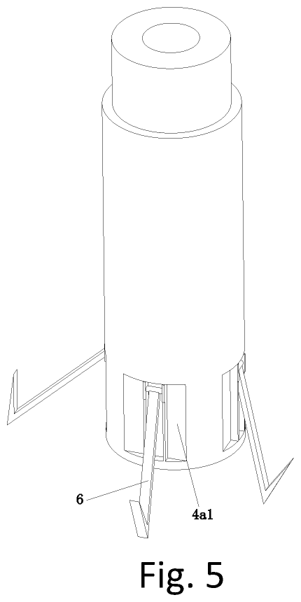

Referring to FIGS. 1-5, a paw type quick guiding dredging device for household sewer pipe includes a feeding air guiding tube 1, a micro air pump 3 and a dredging member 4. One end of the feeding air guiding tube 1 is a closed structure, and the other end is provided with a connecting sleeve 2 communicating with the coaxial line thereof. The dredging member 4 includes an extended air guiding tube 4a and a spherical airbag 4b. One end of the extended air guiding tube 4a is connected with the connecting sleeve 2. The inlet end of the spherical airbag 4b is in communication with the other end of the extended air guiding tube 4a. The spherical airbag 4b, the extended air guiding tube 4a and the connecting sleeve 2 are coaxially arranged, and the outer surface of the spherical airbag 4b is provided with a friction member which is used to clean the inner wall of sewage pipe. One end of the feeding air guiding tube 1 close to the connecting sleeve is further provided with a sliding member for pulling the spherical airbag 4b. The outer surface of the extended air guiding tube 4a is hinged with a hooking member for hooking the blockage in the sewage pipe. The output end of the micro air pump 3 is in communication with the end of the feeding air guiding tube 1 away from the connecting sleeve 2.

The friction member includes a plurality of soft brushes 5 spaced apart in the circumferential direction of the spherical airbag 4b, and the spherical airbag 4b is made of rubber. The soft brush 5 is swung with the spherical airbag 4b to achieve the purpose of cleaning the inner wall of the sewage pipe.

The outer surface of the spherical airbag 4b is provided with a plurality of mounting slots 4b1 distributed along the circumferential direction thereof, and all the mounting slots 4b1 are placed separately from the soft brushes 5. The mounting slots 4b1 are provided with rectangular blocks 4b2, and one side of the rectangular block 4b2 facing outward has a rectangular hinge groove 4b4. The rectangular hinge groove 4b4 is provided with a guide wheel 4b3 that can rotate along its own axis. The guide wheel 4b3 makes the spherical airbag 4b more stable in reciprocating movement, and the arrangement of the rectangular block 4b2 makes the spherical airbag 4b not affect the guide wheel 4b3 when t the spherical airbag 4b is not in the expanded state.

The axial direction of the guide wheel 4b3 is perpendicular to the axial direction of the spherical airbag 4b, and the diameter of the guide wheel 4b3 is larger than the depth of the rectangular hinge groove 4b4. It means that a part of the guide wheel 4b3 is located outside the rectangular hinge groove 4b4, so that the guide wheel 4b3 can contact the inner wall of the sewer pipe, and rolling occurs.

The hooking member includes at least four hooks 6 equally spaced along the circumferential direction of the extended air guiding tube 4a, and the outer side of the extended air guiding tube 4a is provided with at least four rotating slots 4a1 spaced along the circumferential direction thereof. All the hooks 6 respectively correspond to all the rotating slots 4a1, the hooking end of the hook 6 is suspended outside the rotating slot 4a1, and the other end is hingedly disposed in the rotating slot 4a1. The rotating slot 4a1 is disposed at an end of the extended air guiding tube 4a close to the spherical airbag 4b. When the spherical airbag 4b is not inflated, the hook 6 is vertically suspended, and after the spherical airbag 4b is inflated, it abuts against the hooking end of the hook 6, so that the hook 6 is rotated upward to facilitate hooking of the blockage. The product is then manually pulled so that the blockage rises with the hook 6.

The feeding air guiding tube 1 is a rubber hose, and the sliding member includes an elastic rope 7. One end of the elastic rope 7 is fixedly connected with the outer side surface of the feeding air guiding tube 1, and the length of the elastic rope 7 is the same as the length of the feeding air guiding tube 1. The elastic rope 7 is engaged with the feed air guiding tube 1, and the spherical airbag 4b can be moved in the sewerage pipe to move left and right.

The end of the feeding air guiding tube 1 away from the connecting sleeve 2 is provided with a portable handle 8 integrally formed with the feeding air guiding tube 1. The portable handle 8 facilitates to manually operate the product.

The working principle: a hand-held portable hand 8 sequentially inserts a spherical airbag 4b, an extended air guiding tube 4a, an elastic rope 7, a connecting sleeve 2 and a feeding air guiding tube 1 into the sewage pipe. As the feeding air guiding tube 1 is a rubber hose, it passes through the bend of the sewage pipe and does not get stuck. The spherical airbag 4b enters the bend. At this time, one end of the hook 6 is vertically suspended, and the movement of the spherical airbag 4b in the sewage pipe is not affected. Then the air source is manually sent through the feeding air guiding pipe 1, the connecting sleeve 2 and the extended air guiding tube 4a through the micro air pump 3 to the airbag 1, which makes the spherical airbag 4b expand and contact the inner wall of the sewage pipe. During expansion, the upper part of the spherical airbag 4b contacts the hooking end of the hook 6, and make the hook 6 rotate upward, so that the hooking end of the hook 6 contacts the blockage, such as hair. Then one hand manually pulls the portable handle 8, and the other hand pulls the elastic rope 7, which makes the spherical airbag 4b reciprocate in the sewage pipe. The soft brush 5 contacts the dirt in the sewage pipe. At this time, the water source is discharged into the sewage pipe, and the guide wheel 4b3 constitutes a guide, so that the spherical airbag 4b moves. This makes the soft brush 5 clean more sufficiently.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A paw type quick guiding dredging device for household sewer pipe, comprising: a feeding air guiding tube 1, a micro air pump 3 and a dredging member 4, wherein one end of the feeding air guiding tube 1 is a closed structure, and the other end is provided with a connecting sleeve 2 communicating with the coaxial line thereof; the dredging member 4 includes an extended air guiding tube 4a and a spherical airbag 4b; one end of the extended air guiding tube 4a is connected with the connecting sleeve 2; the inlet end of the spherical airbag 4b is in communication with the other end of the extended air guiding tube 4a; the spherical airbag 4b, the extended air guiding tube 4a and the connecting sleeve 2 are coaxially arranged, and the outer surface of the spherical airbag 4b is provided with a friction member which is used to clean the inner wall of sewage pipe; one end of the feeding air guiding tube 1 close to the connecting sleeve is further provided with a sliding member for pulling the spherical airbag 4b; the outer surface of the extended air guiding tube 4a is hinged with a hooking member for hooking the blockage in the sewage pipe; the output end of the micro air pump 3 is in communication with the end of the feeding air guiding tube 1 away from the connecting sleeve 2,
wherein the outer surface of the spherical airbag 4b is provided with a plurality of mounting slots 4b1 distributed along the circumferential direction thereof, and all the mounting slots 4b1 are placed separately from the soft brushes 5; the mounting slots 4b1 are provided with rectangular blocks 4b2, and one side of the rectangular block 4b2 facing outward has a rectangular hinge groove 4b4; the rectangular hinge groove 4b4 is provided with a guide wheel 4b3 that can rotate along its own axis,
wherein the hooking member includes at least four hooks 6 equally spaced along the circumferential direction of the extended air guiding tube 4a, and the outer side of the extended air guiding tube 4a is provided with at least four rotating slots 4a1 spaced along the circumferential direction thereof; all the hooks 6 respectively correspond to all the rotating slots 4a1, the hooking end of the hook 6 is suspended outside the rotating slot 4a1, and the other end is hingedly disposed in the rotating slot 4a1; the rotating slot 4a1 is disposed at an end of the extended air guiding tube 4a close to the spherical airbag 4b.

2. The paw type quick guiding dredging device for household sewer pipe of claim 1, wherein the friction member includes a plurality of soft brushes 5 spaced apart in the circumferential direction of the spherical airbag 4b, and the spherical airbag 4b is made of rubber.

3. The paw type quick guiding dredging device for household sewer pipe of claim 1, wherein the axial direction of the guide wheel 4b3 is perpendicular to the axial direction of the spherical airbag 4b, and the diameter of the guide wheel 4b3 is larger than the depth of the rectangular hinge groove 4b4.

4. The paw type quick guiding dredging device for household sewer pipe of claim 1, wherein the feeding air guiding tube 1 is a rubber hose, and the sliding member includes an elastic rope 7; one end of the elastic rope 7 is fixedly connected with the outer side surface of the feeding air guiding tube 1, and the length of the elastic rope 7 is the same as the length of the feeding air guiding tube 1.

5. The paw type quick guiding dredging device for household sewer pipe of claim 4, wherein the end of the feeding air guiding tube 1 away from the connecting sleeve 2 is provided with a portable handle 8 integrally formed with the feeding air guiding tube 1.
